(19) United States
(12) Patent Application Publication
(10) Pub. No.: US 2026/0101036 A1
(43) Pub. Date: Apr. 9, 2026

(54) OFFSET AND QUANTIZATION INTERVAL FOR CROSS COMPONENT SAMPLE OFFSET

(71) Applicant: Tencent America LLC, Palo Alto, CA (US)

(72) Inventors: Liang ZHAO, Palo Alto, CA (US); Tianqi LIU, Palo Alto, CA (US); Shan LIU, Palo Alto, CA (US); Madhu PERINGASSERY KRISHNAN, Palo Alto, CA (US); Ting-Lan LIN, Palo Alto, CA (US)

(21) Appl. No.: 19/349,846

(22) Filed: Oct. 3, 2025

Related U.S. Application Data
(60) Provisional application No. 63/703,803, filed on Oct. 4, 2024.

(51) Int. Cl. H04N 19/124; G06F 1/03; H04N 19/176

(52) U.S. Cl. CPC H04N 19/124; G06F 1/03; H04N 19/176

(57) ABSTRACT

An example method includes receiving a video bitstream comprising a plurality of blocks, including a current block. The method includes when the current block has a first property, determining a quantization step size for the current block using a first look-up table. The method includes when the current block has a second property, determining the quantization step size for the current block using a second look-up table. The second property is different than the first property and the second look-up table is different than the first look-up table. The method includes reconstructing the current block using the determined quantization step size.

### RELATED APPLICATIONS

This application claims priority to U.S. Provisional Patent Application No. 63/703,803, entitled “Offset and Quantization Interval for Cross Component Sample Offset,” filed Oct. 4, 2024, which is hereby incorporated by reference in its entirety.

### TECHNICAL FIELD

The disclosed embodiments relate generally to video coding, including but not limited to systems and methods for loop filtering (e.g., cross-component offset filtering) of video data.

### BACKGROUND

Digital video is supported by a variety of electronic devices, such as digital televisions, laptop or desktop computers, tablet computers, digital cameras, digital recording devices, digital media players, video gaming consoles, smart phones, video teleconferencing devices, video streaming devices, etc. The electronic devices transmit and receive or otherwise communicate digital video data across a communication network, and/or store the digital video data on a storage device. Due to a limited bandwidth capacity of the communication network and limited memory resources of the storage device, video coding may be used to compress the video data according to one or more video coding standards before it is communicated or stored. The video coding can be performed by hardware and/or software on an electronic/client device or a server providing a cloud service.

Video coding generally utilizes prediction methods (e.g., inter-prediction, intra-prediction, or the like) that take advantage of redundancy inherent in the video data. Video coding aims to compress video data into a form that uses a lower bit rate, while avoiding or minimizing degradations to video quality. Multiple video codec standards have been developed. For example, High-Efficiency Video Coding (HEVC/H.265) is a video compression standard designed as part of the MPEG-H project. ITU-T and ISO/IEC published the HEVC/H.265 standard in 2013 (version 1), 2014 (version 2), 2015 (version 3), and 2016 (version 4). Versatile Video Coding (VVC/H.266) is a video compression standard intended as a successor to HEVC. ITU-T and ISO/IEC published the VVC/H.266 standard in 2020 (version 1) and 2022 (version 2). AOMedia Video 1 (AV1) is an open video coding format designed as an alternative to HEVC. On Jan. 8, 2019, a validated version 1.0.0 with Errata 1 of the specification was released.

### SUMMARY

The present disclosure describes methods, systems, and non-transitory computer-readable storage media for applying loop filtering during video (image) compression. A video codec includes a plurality of function modules for one or more of: intra/inter prediction, transform coding, quantization, entropy coding, and in-loop filtering. In-loop filtering technologies are applied to adjust reconstructed picture samples to further reduce a reconstruction error. A cross-component offset filtering is a filtering process that uses the co-located reconstructed sample and its neighboring reconstructed samples from a first color component as input to derive an offset value that is added on the current sample of a second color component to adjust its reconstructed value. An example of the first color component is a luma color component, and an example of the second color component is a chroma color component.

Cross-component offset filtering is an edge preserving loop filter that uses the reconstructed samples to compute the sample offsets of luma and/or chroma components. In some video encoding technologies, only the luma samples located in positions defined by the filter shape are used to compute the offset of the chroma component or the luma component. Some embodiments of the present disclosure apply different quantization step size (or quantization threshold) look-up tables to (i) different color components, (ii) different input/internal bit depth of video sequences, and/or (iii) different edge classifiers. The application of different quantization step size look-up tables facilitates larger quantization ranges and step sizes, which in turn improve coding efficiency.

In accordance with some embodiments, a method of video decoding is provided. The method includes (i) receiving a video bitstream comprising a plurality of blocks, including a current block; (ii) when the current block has a first property, determining a quantization step size for the current block using a first look-up table; (iii) when the current block has a second property, determining the quantization step size for the current block using a second look-up table, wherein the second property is different than the first property, and wherein the second look-up table is different than the first look-up table; and (iv) reconstructing the current block using the determined quantization step size.

In accordance with some embodiments, a method of video encoding is provided. The method includes (i) receiving video data comprising a plurality of blocks, including a current block; (ii) when the current block has a first property, determining a quantization step size for the current block using a first look-up table; (iii) when the current block has a second property, determining the quantization step size for the current block using a second look-up table, wherein the second property is different than the first property, and wherein the second look-up table is different than the first look-up table; and (iv) encoding the current block using the determined quantization step size.

In accordance with some embodiments, a non-transitory computer-readable storage medium storing a video bitstream is provided. The video bitstream is generated by a video encoding method. The video bitstream comprises coded information for a plurality of blocks including a current block. The video encoding method comprises (i) when the current block has a first property, determining a quantization step size for the current block using a first look-up table; (ii) when the current block has a second property, determining the quantization step size for the current block using a second look-up table, wherein the second property is different than the first property, and wherein the second look-up table is different than the first look-up table; and (iii) encoding the current block using the determined quantization step size.

In accordance with some embodiments, a computing system is provided, such as a streaming system, a server system, a personal computer system, or other electronic device. The computing system includes control circuitry and memory storing one or more sets of instructions. The one or more sets of instructions including instructions for performing any of the methods described herein. In some embodiments, the computing system includes an encoder component and a decoder component (e.g., a transcoder).

In accordance with some embodiments, a non-transitory computer-readable storage medium is provided. The non-transitory computer-readable storage medium stores one or more sets of instructions for execution by a computing system. The one or more sets of instructions including instructions for performing any of the methods described herein.

Thus, devices and systems are disclosed with methods for encoding and decoding video. Such methods, devices, and systems may complement or replace conventional methods, devices, and systems for video encoding/decoding.

The features and advantages described in the specification are not necessarily all-inclusive and, in particular, some additional features and advantages will be apparent to one of ordinary skill in the art in view of the drawings, specification, and claims provided in this disclosure. Moreover, it should be noted that the language used in the specification has been principally selected for readability and instructional purposes and has not necessarily been selected to delineate or circumscribe the subject matter described herein.

### BRIEF DESCRIPTION OF THE DRAWINGS

So that the present disclosure can be understood in greater detail, a more particular description can be had by reference to the features of various embodiments, some of which are illustrated in the appended drawings. The appended drawings, however, merely illustrate pertinent features of the present disclosure and are therefore not necessarily to be considered limiting, for the description can admit to other effective features as the person of skill in this art will appreciate upon reading this disclosure.

FIG. 1 is a block diagram illustrating an example communication system in accordance with some embodiments.

FIG. 2A is a block diagram illustrating example elements of an encoder component in accordance with some embodiments.

FIG. 2B is a block diagram illustrating example elements of a decoder component in accordance with some embodiments.

FIG. 3 is a block diagram illustrating an example server system in accordance with some embodiments.

FIG. 4A illustrates the computation of a prediction block in accordance with some embodiments.

FIG. 4B illustrates the computation of a residue block in accordance with some embodiments.

FIG. 4C illustrates the computation of a reconstructed block in accordance with some embodiments.

FIG. 5 illustrates example in-loop filtering stages in accordance with some embodiments.

FIG. 6A illustrates an example video decoding process in accordance with some embodiments.

FIG. 6B illustrates an example video encoding process in accordance with some embodiments.

In accordance with common practice, the various features illustrated in the drawings are not necessarily drawn to scale, and like reference numerals can be used to denote like features throughout the specification and figures.

### DETAILED DESCRIPTION

The present disclosure describes methods, systems, and non-transitory computer-readable storage media for applying a loop filter for video (image) compression. For example, in-loop filtering technologies are applied to adjust reconstructed picture samples to further reduce a reconstruction error. In some embodiments, cross-component offset filtering is used to apply a collocated reconstructed sample and associated neighboring reconstructed samples of a first color component to derive an offset value that is added on a current sample of a second color component, thereby adjusting a reconstruction value of the current sample. In various embodiments of this application, a video decoder receives a video bitstream from a video encoder, the video bitstream including a current block. The video decoder determines a quantization step size for the current block using a first look-up table when the current block has a first property, and determines the quantization step size for the current block using a second look-up table when the current block has a second property. The second look-up table is different from the first look-up table. The video decoder reconstructs the current block using the determined quantization step size. Applying different look-up tables to determine quantization step sizes according to the property of the current block can improve visual quality while maximizing compression efficiency. By intelligently applying more or less aggressive quantization, the video decoder can allocate more bits to perceptually important regions of a video and fewer to areas where the human eye is less sensitive to details.

### Example Systems and Devices

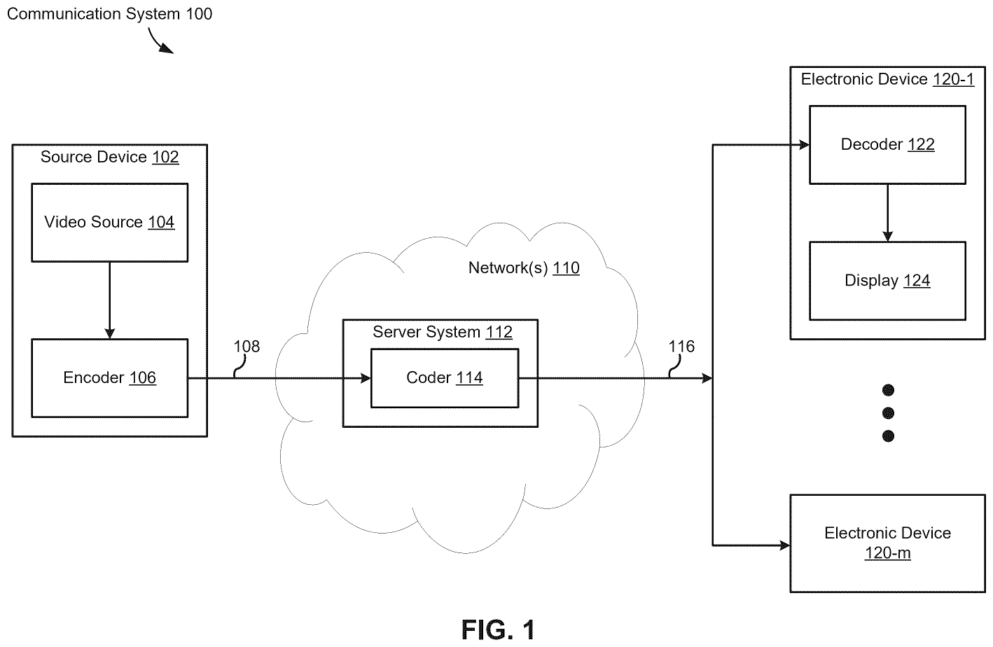

FIG. 1 is a block diagram illustrating a communication system 100 in accordance with some embodiments. The communication system 100 includes a source device 102 and a plurality of electronic devices 120 (e.g., electronic device 120-1 to electronic device 120-m) that are communicatively coupled to one another via one or more networks. In some embodiments, the communication system 100 is a streaming system, e.g., for use with video-enabled applications such as video conferencing applications, digital TV applications, and media storage and/or distribution applications.

The source device 102 includes a video source 104 (e.g., a camera component or media storage) and an encoder component 106. In some embodiments, the video source 104 is a digital camera (e.g., configured to create an uncompressed video sample stream). The encoder component 106 generates one or more encoded video bitstreams from the video stream. The video stream from the video source 104 may be high data volume as compared to the encoded video bitstream 108 generated by the encoder component 106. Because the encoded video bitstream 108 is lower data volume (less data) as compared to the video stream from the video source, the encoded video bitstream 108 requires less bandwidth to transmit and less storage space to store as compared to the video stream from the video source 104. In some embodiments, the source device 102 does not include the encoder component 106 (e.g., is configured to transmit uncompressed video to the network(s) 110).

The one or more networks 110 represents any number of networks that convey information between the source device 102, the server system 112, and/or the electronic devices 120, including for example wireline (wired) and/or wireless communication networks. The one or more networks 110 may exchange data in circuit-switched and/or packet-switched channels. Representative networks include telecommunications networks, local area networks, wide area networks and/or the Internet.

The one or more networks 110 include a server system 112 (e.g., a distributed/cloud computing system). In some embodiments, the server system 112 is, or includes, a streaming server (e.g., configured to store and/or distribute video content such as the encoded video stream from the source device 102). The server system 112 includes a coder component 114 (e.g., configured to encode and/or decode video data). In some embodiments, the coder component 114 includes an encoder component and/or a decoder component. In various embodiments, the coder component 114 is instantiated as hardware, software, or a combination thereof. In some embodiments, the coder component 114 is configured to decode the encoded video bitstream 108 and re-encode the video data using a different encoding standard and/or methodology to generate encoded video data 116. In some embodiments, the server system 112 is configured to generate multiple video formats and/or encodings from the encoded video bitstream 108. In some embodiments, the server system 112 functions as a Media-Aware Network Element (MANE). For example, the server system 112 may be configured to prune the encoded video bitstream 108 for tailoring potentially different bitstreams to one or more of the electronic devices 120. In some embodiments, a MANE is provided separate from the server system 112.

The electronic device 120-1 includes a decoder component 122 and a display 124. In some embodiments, the decoder component 122 is configured to decode the encoded video data 116 to generate an outgoing video stream that can be rendered on a display or other type of rendering device. In some embodiments, one or more of the electronic devices 120 does not include a display component (e.g., is communicatively coupled to an external display device and/or includes a media storage). In some embodiments, the electronic devices 120 are streaming clients. In some embodiments, the electronic devices 120 are configured to access the server system 112 to obtain the encoded video data 116.

The source device and/or the plurality of electronic devices 120 are sometimes referred to as “terminal devices” or “user devices.” In some embodiments, the source device 102 and/or one or more of the electronic devices 120 are instances of a server system, a personal computer, a portable device (e.g., a smartphone, tablet, or laptop), a wearable device, a video conferencing device, and/or other type of electronic device.

In example operation of the communication system 100, the source device 102 transmits the encoded video bitstream 108 to the server system 112. For example, the source device 102 may code a stream of pictures that are captured by the source device. The server system 112 receives the encoded video bitstream 108 and may decode and/or encode the encoded video bitstream 108 using the coder component 114. For example, the server system 112 may apply an encoding to the video data that is more optimal for network transmission and/or storage. The server system 112 may transmit the encoded video data 116 (e.g., one or more coded video bitstreams) to one or more of the electronic devices 120. Each electronic device 120 may decode the encoded video data 116 and optionally display the video pictures.

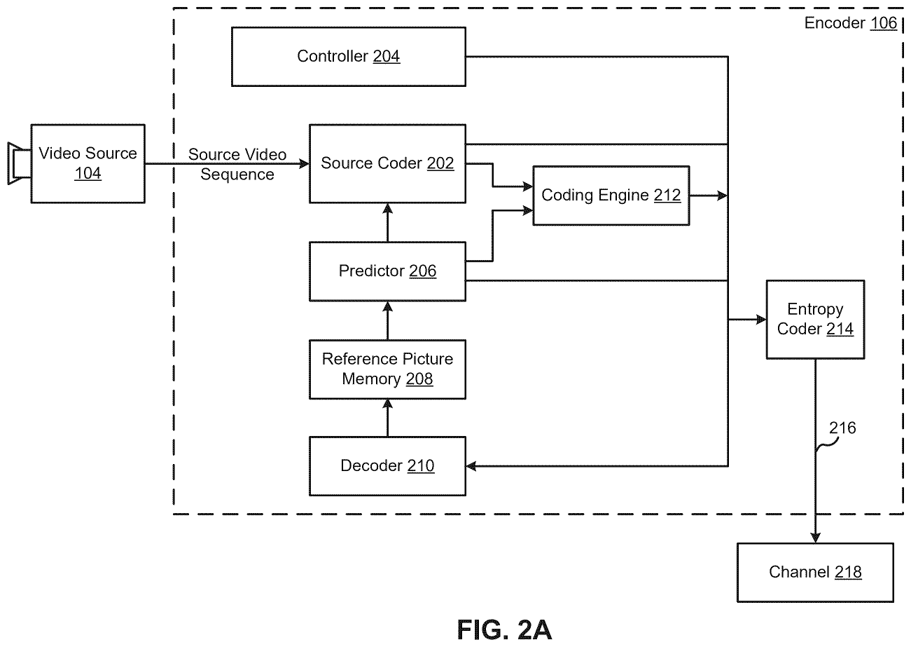

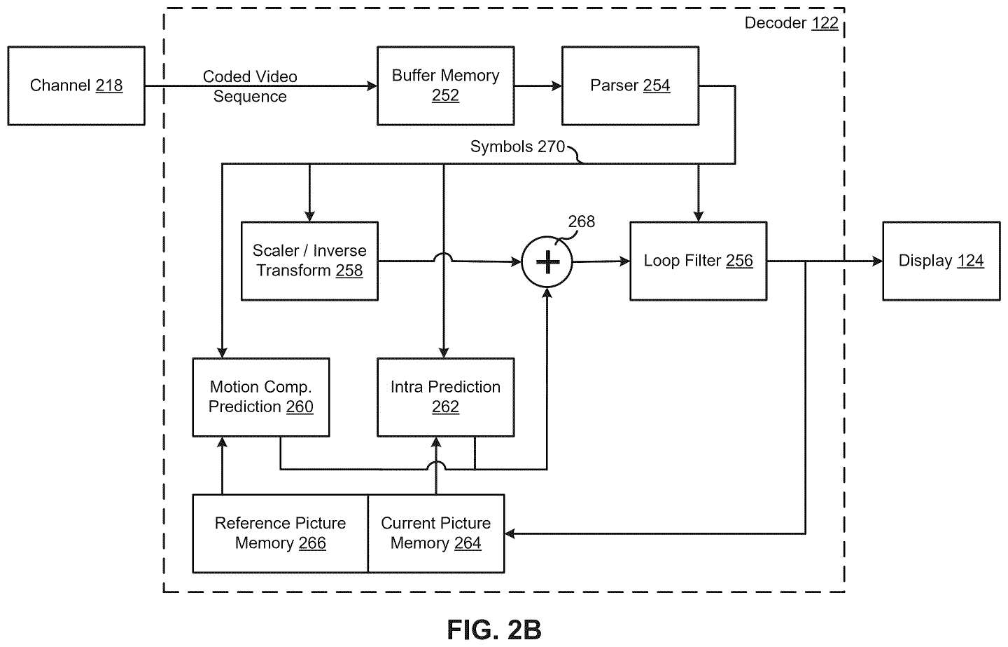

FIG. 2A is a block diagram illustrating example elements of the encoder component 106 in accordance with some embodiments. The encoder component 106 receives video data (e.g., a source video sequence) from the video source 104. In some embodiments, the encoder component includes a receiver (e.g., a transceiver) component configured to receive the source video sequence. In some embodiments, the encoder component 106 receives a video sequence from a remote video source (e.g., a video source that is a component of a different device than the encoder component 106). The video source 104 may provide the source video sequence in the form of a digital video sample stream that can be of any suitable bit depth (e.g., 8-bit, 10-bit, or 12-bit), any colorspace (e.g., BT.601 Y CrCB, or RGB), and any suitable sampling structure (e.g., Y CrCb 4:2:0 or Y CrCb 4:4:4). In some embodiments, the video source 104 is a storage device storing previously captured/prepared video. In some embodiments, the video source 104 is camera that captures local image information as a video sequence. Video data may be provided as a plurality of individual pictures that impart motion when viewed in sequence. The pictures themselves may be organized as a spatial array of pixels, where each pixel can include one or more samples depending on the sampling structure, color space, etc. in use. A person of ordinary skill in the art can readily understand the relationship between pixels and samples.

The encoder component 106 is configured to code and/or compress the pictures of the source video sequence into a coded video sequence 216 in real-time or under other time constraints as required by the application. In some embodiments, the encoder component 106 is configured to perform a conversion between the source video sequence and a bitstream of visual media data (e.g., a video bitstream). Enforcing appropriate coding speed is one function of a controller 204. In some embodiments, the controller 204 controls other functional units as described below and is functionally coupled to the other functional units. Parameters set by the controller 204 may include rate-control-related parameters (e.g., picture skip, quantizer, and/or lambda value of rate-distortion optimization techniques), picture size, group of pictures (GOP) layout, maximum motion vector search range, and so forth. A person of ordinary skill in the art can readily identify other functions of controller 204 as they may pertain to the encoder component 106 being optimized for a certain system design.

In some embodiments, the encoder component 106 is configured to operate in a coding loop. In a simplified example, the coding loop includes a source coder 202 (e.g., responsible for creating symbols, such as a symbol stream, based on an input picture to be coded and reference picture(s)), and a (local) decoder 210. The decoder 210 reconstructs the symbols to create the sample data in a similar manner as a (remote) decoder (when compression between symbols and coded video bitstream is lossless). The reconstructed sample stream (sample data) is input to the reference picture memory 208. As the decoding of a symbol stream leads to bit-exact results independent of decoder location (local or remote), the content in the reference picture memory 208 is also bit exact between the local encoder and remote encoder. In this way, the prediction part of an encoder interprets as reference picture samples the same sample values as a decoder would interpret when using prediction during decoding.

The operation of the decoder 210 can be the same as of a remote decoder, such as the decoder component 122, which is described in detail below in conjunction with FIG. 2B. Briefly referring to FIG. 2B, however, as symbols are available and encoding/decoding of symbols to a coded video sequence by an entropy coder 214 and the parser 254 can be lossless, the entropy decoding parts of the decoder component 122, including the buffer memory 252 and the parser 254 may not be fully implemented in the local decoder 210.

The decoder technology described herein, except the parsing/entropy decoding, may be to be present, in substantially identical functional form, in a corresponding encoder. For this reason, the disclosed subject matter focuses on decoder operation. Additionally, the description of encoder technologies can be abbreviated as they may be the inverse of the decoder technologies.

As part of its operation, the source coder 202 may perform motion compensated predictive coding, which codes an input frame predictively with reference to one or more previously-coded frames from the video sequence that were designated as reference frames. In this manner, the coding engine 212 codes differences between pixel blocks of an input frame and pixel blocks of reference frame(s) that may be selected as prediction reference(s) to the input frame. The controller 204 may manage coding operations of the source coder 202, including, for example, setting of parameters and subgroup parameters used for encoding the video data.

The decoder 210 decodes coded video data of frames that may be designated as reference frames, based on symbols created by the source coder 202. Operations of the coding engine 212 may advantageously be lossy processes. When the coded video data is decoded at a video decoder (not shown in FIG. 2A), the reconstructed video sequence may be a replica of the source video sequence with some errors. The decoder 210 replicates decoding processes that may be performed by a remote video decoder on reference frames and may cause reconstructed reference frames to be stored in the reference picture memory 208. In this manner, the encoder component 106 stores copies of reconstructed reference frames locally that have common content as the reconstructed reference frames that will be obtained by a remote video decoder (absent transmission errors).

The predictor 206 may perform prediction searches for the coding engine 212. That is, for a new frame to be coded, the predictor 206 may search the reference picture memory 208 for sample data (as candidate reference pixel blocks) or certain metadata such as reference picture motion vectors, block shapes, and so on, that may serve as an appropriate prediction reference for the new pictures. The predictor 206 may operate on a sample block-by-pixel block basis to find appropriate prediction references. As determined by search results obtained by the predictor 206, an input picture may have prediction references drawn from multiple reference pictures stored in the reference picture memory 208.

Output of all aforementioned functional units may be subjected to entropy coding in the entropy coder 214. The entropy coder 214 translates the symbols as generated by the various functional units into a coded video sequence, by losslessly compressing the symbols according to technologies known to a person of ordinary skill in the art (e.g., Huffman coding, variable length coding, and/or arithmetic coding).

In some embodiments, an output of the entropy coder 214 is coupled to a transmitter. The transmitter may be configured to buffer the coded video sequence(s) as created by the entropy coder 214 to prepare them for transmission via a communication channel 218, which may be a hardware/software link to a storage device which would store the encoded video data. The transmitter may be configured to merge coded video data from the source coder 202 with other data to be transmitted, for example, coded audio data and/or ancillary data streams (sources not shown). In some embodiments, the transmitter may transmit additional data with the encoded video. The source coder 202 may include such data as part of the coded video sequence. Additional data may comprise temporal/spatial/SNR enhancement layers, other forms of redundant data such as redundant pictures and slices, Supplementary Enhancement Information (SEI) messages, Visual Usability Information (VUI) parameter set fragments, and the like.

The controller 204 may manage operation of the encoder component 106. During coding, the controller 204 may assign to each coded picture a certain coded picture type, which may affect the coding techniques that are applied to the respective picture. For example, pictures may be assigned as an Intra Picture (I picture), a Predictive Picture (P picture), or a Bi-directionally Predictive Picture (B Picture). An Intra Picture may be coded and decoded without using any other frame in the sequence as a source of prediction. Some video codecs allow for different types of Intra pictures, including, for example Independent Decoder Refresh (IDR) Pictures. A person of ordinary skill in the art is aware of those variants of I pictures and their respective applications and features, and therefore they are not repeated here. A Predictive picture may be coded and decoded using intra prediction or inter prediction using at most one motion vector and reference index to predict the sample values of each block. A Bi-directionally Predictive Picture may be coded and decoded using intra prediction or inter prediction using at most two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded non-predictively, via spatial prediction or via temporal prediction with reference to one previously coded reference pictures. Blocks of B pictures may be coded non-predictively, via spatial prediction or via temporal prediction with reference to one or two previously coded reference pictures.

A video may be captured as a plurality of source pictures (video pictures) in a temporal sequence. Intra-picture prediction (often abbreviated to intra prediction) makes use of spatial correlation in a given picture, and inter-picture prediction makes uses of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture, in case multiple reference pictures are in use.

The encoder component 106 may perform coding operations according to a predetermined video coding technology or standard, such as any described herein. In its operation, the encoder component 106 may perform various compression operations, including predictive coding operations that exploit temporal and spatial redundancies in the input video sequence. The coded video data, therefore, may conform to a syntax specified by the video coding technology or standard being used.

FIG. 2B is a block diagram illustrating example elements of the decoder component 122 in accordance with some embodiments. The decoder component 122 in FIG. 2B is coupled to the channel 218 and the display 124. In some embodiments, the decoder component 122 includes a transmitter coupled to the loop filter 256 and configured to transmit data to the display 124 (e.g., via a wired or wireless connection).

In some embodiments, the decoder component 122 includes a receiver coupled to the channel 218 and configured to receive data from the channel 218 (e.g., via a wired or wireless connection). The receiver may be configured to receive one or more coded video sequences to be decoded by the decoder component 122. In some embodiments, the decoding of each coded video sequence is independent from other coded video sequences. Each coded video sequence may be received from the channel 218, which may be a hardware/software link to a storage device which stores the encoded video data. The receiver may receive the encoded video data with other data, for example, coded audio data and/or ancillary data streams, that may be forwarded to their respective using entities (not depicted). The receiver may separate the coded video sequence from the other data. In some embodiments, the receiver receives additional (redundant) data with the encoded video. The additional data may be included as part of the coded video sequence(s). The additional data may be used by the decoder component 122 to decode the data and/or to more accurately reconstruct the original video data. Additional data can be in the form of, e.g., temporal, spatial, or SNR enhancement layers, redundant slices, redundant pictures, forward error correction codes, and so on.

In accordance with some embodiments, the decoder component 122 includes a buffer memory 252, a parser 254 (also sometimes referred to as an entropy decoder), a scaler/inverse transform unit 258, an intra picture prediction unit 262, a motion compensation prediction unit 260, an aggregator 268, the loop filter unit 256, a reference picture memory 266, and a current picture memory 264. In some embodiments, the decoder component 122 is implemented as an integrated circuit, a series of integrated circuits, and/or other electronic circuitry. The decoder component 122 may be implemented at least in part in software.

The buffer memory 252 is coupled in between the channel 218 and the parser 254 (e.g., to combat network jitter). In some embodiments, the buffer memory 252 is separate from the decoder component 122. In some embodiments, a separate buffer memory is provided between the output of the channel 218 and the decoder component 122. In some embodiments, a separate buffer memory is provided outside of the decoder component 122 (e.g., to combat network jitter) in addition to the buffer memory 252 inside the decoder component 122 (e.g., which is configured to handle playout timing). When receiving data from a store/forward device of sufficient bandwidth and controllability, or from an isosynchronous network, the buffer memory 252 may not be needed, or can be small. For use on best effort packet networks such as the Internet, the buffer memory 252 may be required, can be comparatively large and/or of adaptive size, and may at least partially be implemented in an operating system or similar elements outside of the decoder component 122.

The parser 254 is configured to reconstruct symbols 270 from the coded video sequence. The symbols may include, for example, information used to manage operation of the decoder component 122, and/or information to control a rendering device such as the display 124. The control information for the rendering device(s) may be in the form of, for example, Supplementary Enhancement Information (SEI) messages or Video Usability Information (VUI) parameter set fragments (not depicted). The parser 254 parses (entropy-decodes) the coded video sequence. The coding of the coded video sequence can be in accordance with a video coding technology or standard, and can follow principles well known to a person skilled in the art, including variable length coding, Huffman coding, arithmetic coding with or without context sensitivity, and so forth. The parser 254 may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser 254 may also extract, from the coded video sequence, information such as transform coefficients, quantizer parameter values, motion vectors, and so forth.

Reconstruction of the symbols 270 can involve multiple different units depending on the type of the coded video picture or parts thereof (such as: inter and intra picture, inter and intra block), and other factors. Which units are involved, and how they are involved, can be controlled by the subgroup control information that was parsed from the coded video sequence by the parser 254. The flow of such subgroup control information between the parser 254 and the multiple units below is not depicted for clarity.

The decoder component 122 can be conceptually subdivided into a number of functional units, and in some implementations, these units interact closely with each other and can, at least partly, be integrated into each other. However, for clarity, the conceptual subdivision of the functional units is maintained herein.

The scaler/inverse transform unit 258 receives quantized transform coefficients as well as control information (such as which transform to use, block size, quantization factor, and/or quantization scaling matrices) as symbol(s) 270 from the parser 254. The scaler/inverse transform unit 258 can output blocks including sample values that can be input into the aggregator 268. In some cases, the output samples of the scaler/inverse transform unit 258 pertain to an intra coded block; that is: a block that is not using predictive information from previously reconstructed pictures, but can use predictive information from previously reconstructed parts of the current picture. Such predictive information can be provided by the intra picture prediction unit 262. The intra picture prediction unit 262 may generate a block of the same size and shape as the block under reconstruction, using surrounding already-reconstructed information fetched from the current (partly reconstructed) picture from the current picture memory 264. The aggregator 268 may add, on a per sample basis, the prediction information the intra picture prediction unit 262 has generated to the output sample information as provided by the scaler/inverse transform unit 258.

In other cases, the output samples of the scaler/inverse transform unit 258 pertain to an inter coded, and potentially motion-compensated, block. In such cases, the motion compensation prediction unit 260 can access the reference picture memory 266 to fetch samples used for prediction. After motion compensating the fetched samples in accordance with the symbols 270 pertaining to the block, these samples can be added by the aggregator 268 to the output of the scaler/inverse transform unit 258 (in this case called the residual samples or residual signal) so to generate output sample information. The addresses within the reference picture memory 266, from which the motion compensation prediction unit 260 fetches prediction samples, may be controlled by motion vectors. The motion vectors may be available to the motion compensation prediction unit 260 in the form of symbols 270 that can have, for example, X, Y, and reference picture components. Motion compensation may also include interpolation of sample values as fetched from the reference picture memory 266, e.g., when sub-sample exact motion vectors are in use, motion vector prediction mechanisms.

The output samples of the aggregator 268 can be subject to various loop filtering techniques in the loop filter unit 256. Video compression technologies can include in-loop filter technologies that are controlled by parameters included in the coded video bitstream and made available to the loop filter unit 256 as symbols 270 from the parser 254, but can also be responsive to meta-information obtained during the decoding of previous (in decoding order) parts of the coded picture or coded video sequence, as well as responsive to previously reconstructed and loop-filtered sample values. The output of the loop filter unit 256 can be a sample stream that can be output to a render device such as the display 124, as well as stored in the reference picture memory 266 for use in future inter-picture prediction.

Certain coded pictures, once reconstructed, can be used as reference pictures for future prediction. Once a coded picture is reconstructed and the coded picture has been identified as a reference picture (by, for example, parser 254), the current reference picture can become part of the reference picture memory 266, and a fresh current picture memory can be reallocated before commencing the reconstruction of the following coded picture.

The decoder component 122 may perform decoding operations according to a predetermined video compression technology that may be documented in a standard, such as any of the standards described herein. The coded video sequence may conform to a syntax specified by the video compression technology or standard being used, in the sense that it adheres to the syntax of the video compression technology or standard, as specified in the video compression technology document or standard and specifically in the profiles document therein. Also, for compliance with some video compression technologies or standards, the complexity of the coded video sequence may be within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

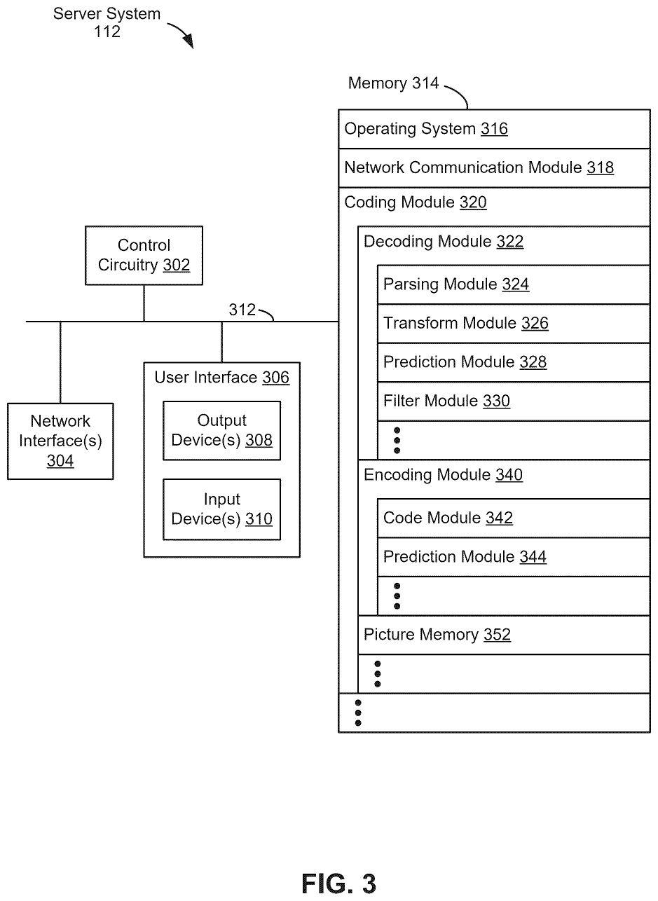

FIG. 3 is a block diagram illustrating the server system 112 in accordance with some embodiments. The server system 112 includes control circuitry 302, one or more network interfaces 304, a memory 314, a user interface 306, and one or more communication buses 312 for interconnecting these components. In some embodiments, the control circuitry 302 includes one or more processors (e.g., a CPU, GPU, and/or DPU). In some embodiments, the control circuitry includes field-programmable gate array(s), hardware accelerators, and/or integrated circuit(s) (e.g., an application-specific integrated circuit).

The network interface(s) 304 may be configured to interface with one or more communication networks (e.g., wireless, wireline, and/or optical networks). The communication networks can be local, wide-area, metropolitan, vehicular and industrial, real-time, delay-tolerant, and so on. Examples of communication networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Such communication can be unidirectional, receive only (e.g., broadcast TV), unidirectional send-only (e.g., CANbus to certain CANbus devices), or bi-directional (e.g., to other computer systems using local or wide area digital networks). Such communication can include communication to one or more cloud computing networks.

The user interface 306 includes one or more output devices 308 and/or one or more input devices 310. The input device(s) 310 may include one or more of: a keyboard, a mouse, a trackpad, a touch screen, a data-glove, a joystick, a microphone, a scanner, a camera, or the like. The output device(s) 308 may include one or more of: an audio output device (e.g., a speaker), a visual output device (e.g., a display or monitor), or the like.

The memory 314 may include high-speed random-access memory (such as DRAM, SRAM, DDR RAM, and/or other random access solid-state memory devices) and/or non-volatile memory (such as one or more magnetic disk storage devices, optical disk storage devices, flash memory devices, and/or other non-volatile solid-state storage devices). The memory 314 optionally includes one or more storage devices remotely located from the control circuitry 302. The memory 314, or, alternatively, the non-volatile solid-state memory device(s) within the memory 314, includes a non-transitory computer-readable storage medium. In some embodiments, the memory 314, or the non-transitory computer-readable storage medium of the memory 314, stores the following programs, modules, instructions, and data structures, or a subset or superset thereof:
an operating system 316 that includes procedures for handling various basic system services and for performing hardware-dependent tasks;
a network communication module 318 that is used for connecting the server system 112 to other computing devices via the one or more network interfaces 304 (e.g., via wired and/or wireless connections);
a coding module 320 for performing various functions with respect to encoding and/or decoding data, such as video data. In some embodiments, the coding module 320 is an instance of the coder component 114. The coding module 320 including, but not limited to, one or more of:
   a decoding module 322 for performing various functions with respect to decoding encoded data, such as those described previously with respect to the decoder component 122; and
   an encoding module 340 for performing various functions with respect to encoding data, such as those described previously with respect to the encoder component 106; and
a picture memory 352 for storing pictures and picture data, e.g., for use with the coding module 320. In some embodiments, the picture memory 352 includes one or more of: the reference picture memory 208, the buffer memory 252, the current picture memory 264, and the reference picture memory 266.

In some embodiments, the decoding module 322 includes a parsing module 324 (e.g., configured to perform the various functions described previously with respect to the parser 254), a transform module 326 (e.g., configured to perform the various functions described previously with respect to the scalar/inverse transform unit 258), a prediction module 328 (e.g., configured to perform the various functions described previously with respect to the motion compensation prediction unit 260 and/or the intra picture prediction unit 262), and a filter module 330 (e.g., configured to perform the various functions described previously with respect to the loop filter 256).

In some embodiments, the encoding module 340 includes a code module 342 (e.g., configured to perform the various functions described previously with respect to the source coder 202 and/or the coding engine 212) and a prediction module 344 (e.g., configured to perform the various functions described previously with respect to the predictor 206). In some embodiments, the decoding module 322 and/or the encoding module 340 include a subset of the modules shown in FIG. 3. For example, a shared prediction module is used by both the decoding module 322 and the encoding module 340.

Each of the above identified modules stored in the memory 314 corresponds to a set of instructions for performing a function described herein. The above identified modules (e.g., sets of instructions) need not be implemented as separate software programs, procedures, or modules, and thus various subsets of these modules may be combined or otherwise re-arranged in various embodiments. For example, the coding module 320 optionally does not include separate decoding and encoding modules, but rather uses a same set of modules for performing both sets of functions. In some embodiments, the memory 314 stores a subset of the modules and data structures identified above. In some embodiments, the memory 314 stores additional modules and data structures not described above.

Although FIG. 3 illustrates the server system 112 in accordance with some embodiments, FIG. 3 is intended more as a functional description of the various features that may be present in one or more server systems rather than a structural schematic of the embodiments described herein. In practice, items shown separately could be combined and some items could be separated. For example, some items shown separately in FIG. 3 could be implemented on single servers and single items could be implemented by one or more servers. The actual number of servers used to implement the server system 112, and how features are allocated among them, will vary from one implementation to another and, optionally, depends in part on the amount of data traffic that the server system handles during peak usage periods as well as during average usage periods.

### Example Coding Techniques

The coding processes and techniques described below may be performed at the devices and systems described above (e.g., the source device 102, the server system 112, and/or the electronic device 120). According to some embodiments, methods for loop filtering (e.g., cross-component offset filtering) are described.

Digital video compression is a technology that enables efficient storage and transmission of video data across a wide range of devices and networks. Conventional video coding standards, such as H.264, H.265/HEVC, and H.266/VVC, employ various modules, including intra/inter prediction, transform coding, quantization, entropy coding, and in-loop filtering, to reduce data redundancy and achieve high compression efficiency. Among these, in-loop filtering contributes significantly to improving the quality of reconstructed video by reducing artifacts introduced during compression. However, existing in-loop filtering techniques, such as deblocking filters and constrained directional enhancement filters, often fail to fully exploit the correlation between color components (e.g., luma and chroma) in video data. This limitation results in less-than-optimal reconstruction quality, particularly for chroma components, which are often encoded with fewer bits than luma components. Furthermore, conventional approaches typically apply uniform quantization and offset parameters across different color components, edge classifiers, and bit depths, leading to inefficiencies in coding performance and visual quality.

The present disclosure addresses these limitations by introducing a cross-component sample offset (CCSO) filtering method that dynamically adjusts quantization step sizes and offset values based on the properties of the video data. Unlike prior techniques, the disclosed approach applies distinct quantization step size look-up tables (LUTs) and offset LUTs tailored to different color components, input/internal bit depths, and edge classifiers. For example, the present disclosure describes using non-negative quantization step sizes for edge classifiers with three intervals, while allowing negative or zero values for edge classifiers with two intervals, thereby enabling finer control over reconstruction quality. Additionally, the present disclosure describe scaling factors derived from the input/internal bit depth and color component, ensuring that quantization and offset parameters are optimally adapted to the characteristics of the video sequence. These implementations enable the CCSO filter to preserve edge details, reduce reconstruction errors, and allocate bits more efficiently across luma and chroma components.

In some embodiments a three-step process is used to derive offset values: (1) calculating delta values using co-located and neighboring reconstructed samples from a first color component, (2) quantizing the delta values into edge classes using scalar quantizers with configurable intervals, and (3) determining offset values based on the edge classes using specialized LUTs. By incorporating these steps, the described systems achieve improved coding efficiency and visual quality. Furthermore, the system architecture supports the concurrent operation of CCSO filtering with other in-loop filters, such as deblocking and constrained directional enhancement filters, to enhance the overall effectiveness of the video coding pipeline. This approach not only improves the reconstructed video quality but also ensures compatibility with existing video coding standards, making the solution adaptable and practical for modern video compression systems.

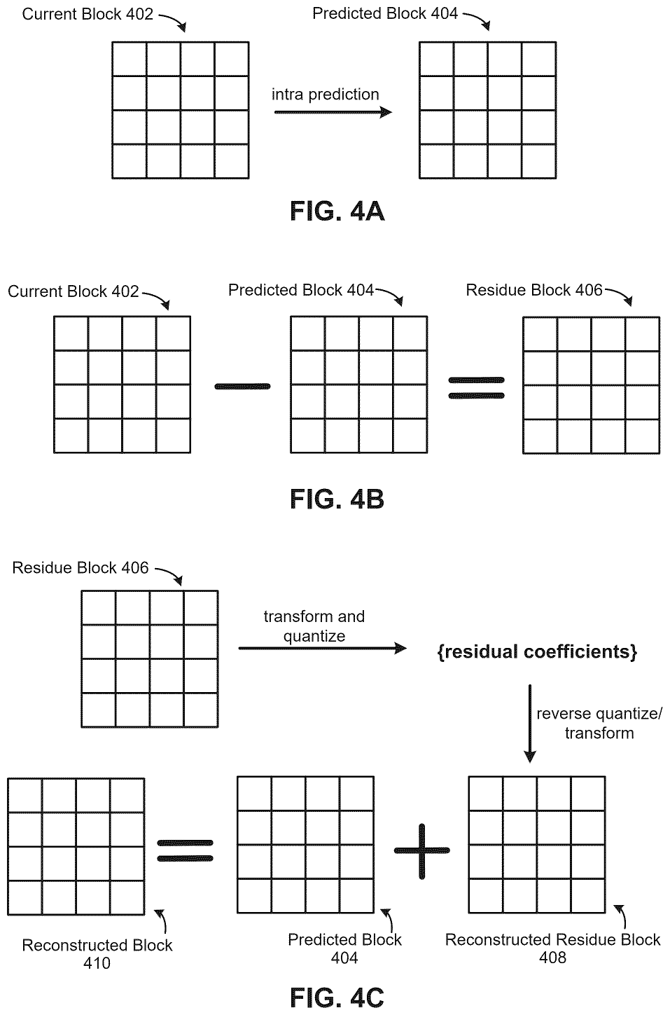

FIGS. 4A-4C illustrate an overview of a quantization and subsequent dequantization process. FIG. 4A illustrates the computation of a prediction block in accordance with some embodiments. In the example of FIG. 4A, an intra prediction is performed on a current block 402 to generate a predicted block 404. The current block 402 includes a set of samples (e.g., pixel blocks) and the prediction block 404 includes a set of predictions that correspond to the set of samples. FIG. 4B illustrates the computation of a residue block in accordance with some embodiments. As shown in FIG. 4B, the prediction block 404 is subtracted from the current block 402 to generate a residue block 406 that includes a set of residues. For example, respective differences are calculated between each sample and the corresponding prediction. FIG. 4C illustrates the computation of a reconstructed block in accordance with some embodiments. As shown in FIG. 4C, the residue block 406 undergoes one or more transformations and quantization to generate a set of residual coefficients. The set of residual coefficients may be transmitted from an encoder component to a decoder component. The set of residual coefficients undergo a reverse quantization and reverse transformation to generate a reconstructed residue block 408. The reconstructed residue block 408 is combined with the predicted block 404 (e.g., reconstructed residues of the reconstructed residue block 408 are added to predictions of the prediction block 404) to generate a reconstructed block 410 corresponding to the current block 402.

Notably, the transforms performed during decoding of the video bitstream may be inverses of the transformed performed during encoding of the video bitstream, and are sometimes referred to as “inverse transforms”. For simplicity, the transformations described herein may be referred to as “transforms” whether performed during encoding or decoding.

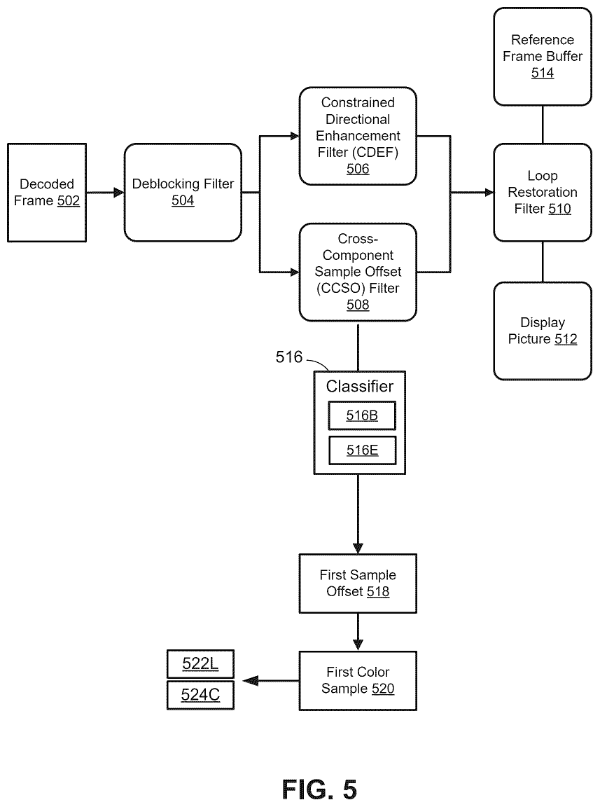

FIG. 5 illustrates example in-loop filtering stages in accordance with some embodiments. In the example of FIG. 5, the in-loop filtering stages applied to the decoded frame 502 include a deblocking filter 504, a constrained direction enhancement filter (CDEF) 506, a cross-component sample offset (CCSO) filter 508 and a loop restoration filter 510. In some embodiments, the filtered output frame is used as a reference frame for later frames (e.g., stored in a reference frame buffer 514). In some embodiments, a normative film grain synthesis stage is also applied to generate a corresponding displayed picture 512. Unlike the in-loop filter stages, the results of the film grain synthesis stage (e.g., an out-of-loop filter) does not influence the prediction for subsequent frames. The loop filtering methods may include any filtering process applied on the reconstructed samples (e.g., after adding residual to the prediction), including wiener loop filtering, cross-component filtering via CCSO filter 508, and constrained directional enhancement filter (CDEF) 506.

In some embodiments, a CCSO filtering method may use (e.g., by applying CCSO filter 508) a co-located reconstructed sample and neighboring reconstructed samples from a first color component as input, to perform filtering of the current reconstruction sample of a second color component. In some embodiments, a CCSO filtering method may use (e.g., by applying CCSO filter 508) the co-located reconstructed sample and its neighboring reconstructed samples from a first color component as input, to derive an offset value that is added on the current sample of a second color component to adjust its reconstruction value. The first color component may refer to a luma color component, and the second color component may refer to a chroma color component. The first color component and second color component may be the same color component (e.g., a luma component). The CCSO filter 508 may produce offset values, which are added to the reconstructed samples of the luma and chroma components to reduce reconstruction error.

In some embodiments, the CCSO filter 508 may operate concurrently with CDEF 506. For example, the reconstructed samples following deblocking 504 may be used as input for both the CDEF 506 and the CCSO filter 508.

The deblocking filter 504 may be applied across the transform block boundaries to remove block artifacts caused by the quantization error. In some embodiments, a filter length is determined based on the minimum transform block sizes on both sides. In some embodiments, finite impulse response (FIR) filters (e.g., low-pass filters) are used by the deblocking filter 504. Edge detection may be used to disable the deblocking filter at transitions that contain a high variance signal (e.g., to avoid blurring an actual edge in the original image). In this way, a deblocking filtering method may be applied on reconstructions samples located close to block boundaries. The block boundaries may include a transform block boundary, a motion compensation block boundary, a coding block boundary, and/or a fixed block size boundary.

The CDEF 506 applies a non-linear de-ringing filter along particular (e.g., oblique) directions. The CDEF 506 may operate on an output of the deblocking filter 504. The CDEF 506 may operate in 8×8 units. In some embodiments, 8 preset directions are defined by rotating and reflecting templates of preset directions. The decoder may use the reconstructed pixels to select the prevalent direction index. A primary filter may be applied along the selected direction, and a secondary filter may be applied along an offset direction (e.g., oriented 45° off the primary direction). In some embodiments, up to 8 groups of filter parameters are signaled (e.g., in a frame header). The groups of filter parameters may include the primary and secondary filter strength indexes of luma and chroma components. The CDEF may apply filtering on reconstruction samples by identifying the direction of each block and then adaptively filtering with a high degree of control over the filter strength along the direction and across it.

In some embodiments, the loop restoration filter 510 is applied to reconstructed pixels after any prior in-loop filtering stages (e.g., the deblocking filter 504, the CDEF 506, and/or CCSO filter 508). The loop restoration filter 510 may be applied to loop restoration units (LRU), e.g., 64×64, 128×128, and/or 256×256 pixel blocks. Bypass filtering, a wiener filter (e.g., a wiener loop filtering method), and/or a self-guided filter may be applied to each LRU independently. A wiener loop filtering method may use a linear weighted sum of the current reconstruction sample and multiple spatially neighboring reconstruction samples as input to derive a modified value for the current reconstruction sample as the output.

CCSO is designed for improved loop filtering on both luma and chroma components. In some embodiments, the filtering process of CCSO involves three main steps. First, the current reconstructed luma samples (e.g., the output of the deblocking process) are classified using classifiers 516. There are two types of classifiers: the edge-offset (EO) classifier 516E and the band-offset (BO) classifier 516B. These classifiers can operate jointly or individually based on indicators signaled at the frame level. Second, the class associated with the current luma sample is used as an index to fetch offset values from a lookup table (LUT), which is determined at the frame level with entries selected from a limited number of predefined values. This LUT is shared across the entire frame. Finally, the derived offset values using the LUT and class index are added to the corresponding luma and chroma components. A filter unit-level on/off flag (non-overlapped 256× 256 luma samples) is signaled to indicate whether CCSO filtering is applied for the associated filter unit.

With continued reference to FIG. 5, in some embodiments associated with band offset classification, the CCSO filtering method comprises a band offset classifier 516B. Based on the band offset classifier 516B, the decoder 122 may determine that a set of target luma samples includes a first luma sample and one or more neighboring luma samples. The set of target luma samples are provided to a quantizer, and used to generate one or more quantized values, which are further applied by the band offset classifier 516B to classify the first color sample 520. In some embodiments associated with edge offset classification, the CCSO filtering method comprises an edge offset classifier 516E. Based on the edge offset classifier 516E, the decoder 122 may determine that a set of target luma samples includes a first luma sample and one or more neighboring luma samples. Difference values of the neighboring luma samples and the first luma sample are provided to a quantizer, and used to generate one or more quantized values, which are further applied by the edge offset classifier 516E to classify the first color sample 520. In some embodiments, the first color sample 520 is classified, e.g., by the classifier 516, based on the quantized values to determine the first sample offset 518 of the first color sample 520. The first color sample 520 is adjusted based on the first sample offset 518 of the first color sample 520, thereby enabling reconstruction of the current image frame. In some embodiments, the first color sample 520 includes a first chroma sample 524C that is co-located with the first luma sample 522L in the current image frame, and the first chroma sample 524C is adjusted based on the first sample offset 518. Alternatively, in some embodiments, the first color sample 520 is the first luma sample 522L, and the first luma sample 524C is adjusted based on the first sample offset 518.

As discussed above, a cross-component offset filtering method is a filtering process using the co-located reconstructed sample and its neighboring reconstructed samples from a first color component as input, to derive an offset value that is added on the current sample of a second color component to adjust its reconstructed value. Examples of the first color component is luma color component, and examples of the second color component is chroma color component. The first color component and second color component can be the same color component, e.g., luma.

The cross-component offset filtering method is an edge preserving loop filter that uses the reconstructed samples to compute the sample offsets of luma and/or chroma components. In some embodiments, only the luma samples located in positions defined by the filter shape are used to compute the offset of the chroma component or the luma component. In some embodiments, the offset value may be derived by three steps:
In the first step, delta values are derived using the co-located reconstructed sample and its neighboring reconstructed samples from a first color component. For example, one or multiple difference values between the co-located reconstructed sample and its neighboring reconstructed samples from a first color component are calculated. The positions of the neighboring reconstructed samples are selected based on a given filter shape.
In the second step, the derived delta values are quantized into multiple edge classes using a scalar quantizer. A scalar quantizer is specified by quantization intervals. A quantization interval may be defined to be the range of values assigned to the same integer, and quantization level is defined as the integer value that all values with a quantization interval are assigned to be.
In the third step, given the quantized derived values (or quantization level) as a classifier, an offset value is determined based on the corresponding classifier. For instance, there are two look-up tables, and the first look-up table stores all the supported offset values (e.g., {−10, −7, −3, −1, 0, 1, 3, 7}), and the second look-up table lists the selected offset value for each combination of quantization levels.

In some embodiments, the number of edge classes can be 2 or 3 based on the number of quantization threshold. For example, if there are two quantization thresholds, the number of edge classes is three. In another example, if there is only one quantization threshold, the number of edge classes is two.

In AVM, two bits are signaled to indicate which quantization threshold is used, where the allowed four quantization step thresholds are [16, 8, 32, 64]. One bit is signaled into the bitstream to indicate the edge classifier. For the first edge classifier, two quantization thresholds are employed, where one of the thresholds is the selected quantization threshold and the other quantization threshold is the negative value of the selected quantization threshold. For the second edge classifier, one quantization threshold is employed, and this quantization threshold is equal to the negative value of the selected quantization step size.

In some embodiments, for the derived offset values, only eight values are supported, and they are stored in one look-up table {−10, −7, −3, −1, 0, 1, 3, 7}. For each classifier, it may select one of the offset values in this look-up table. Both luma and chroma are sharing the same supported offset values, and this look-up table is the same regardless of the input depth of the video sequence or the internal depth of the video sequence.

Some embodiments signal a first scaling factor {1, 2, 3, 4} for derived offset values and these derived offset values can be multiplied with the selected scaling factor in the look-up table. Some embodiments expand the quantization step size, and each color component in each frame can select one of them based on the value of a scale index (scale_idx).

$$quantization\_step \_size [ scale\_idx ] [ 4 ] = \{ \{ 16 , 8 , 32 , 0 \} , \{ 32 , 16 , 64 , 128 \} , \{ 48 , 24 , 96 , 196 \} , \{ 64 , 32 , 128 , 256 \} \} ;$$

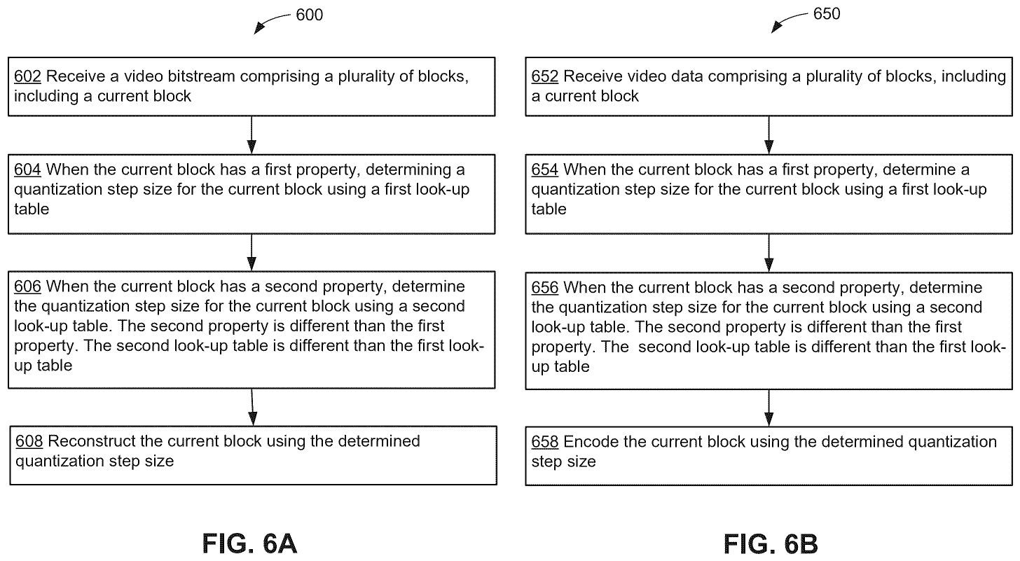

FIG. 6A is a flow diagram illustrating a method 600 of decoding video in accordance with some embodiments. The method 600 may be performed at a computing system (e.g., the server system 112, the source device 102, or the electronic device 120) having control circuitry and memory storing instructions for execution by the control circuitry. In some embodiments, the method 600 is performed by executing instructions stored in the memory (e.g., the memory 314) of the computing system.

The system receives (602) a video bitstream comprising a plurality of blocks, including a current block. When the current block has a first property, the system determines (604) a quantization step size for the current block using a first look-up table. When the current block has a second property, the system determines (606) the quantization step size for the current block using a second look-up table. The second property is different than the first property. The second look-up table is different than the first look-up table. The system reconstructs (608) the current block using the determined quantization step size. In this way, different quantization step size (or quantization threshold) look-up tables may be applied to different color components, different input/internal bit depth of video sequences, and/or different edge classifiers.

In some embodiments, all the quantization step sizes in the first look-up table are non-negative (or positive) integers for the first set of edge classifier whereas at least one of the quantization step sizes in the second look-up table are negative (or zero) integer for the second set of edge classifier.

In some embodiments, all the quantization step sizes in the look-up table are non-negative (or positive) integers for the edge classier with 3 intervals whereas there is at least one quantization step size is negative (or zero) integer for the edge classifier with 2 quantization intervals. In one example, half of the quantization step sizes for the edge classifier with 2 quantization intervals are negative integers. In another example, the quantization step sizes for the edge classifier with 2 quantization intervals are {16, 32, −16, −32}. In yet another example, the quantization step sizes for the edge classifier with 2 quantization intervals are {8, 16, −8, −16}.

In some embodiments, the quantization step size look-up tables may depend on the input or internal bit depth of the video sequences.

In some embodiments, the quantization step sizes values from the look-up table may be multiplied by one scaling factor which is derived based on the input/internal bit-depth of the video sequences. In one example, when the internal/input bit depth of the video sequence is equal to 10, no further scaling factor is applied. If the internal/input bit depth of the video sequence is smaller than 10, such as 8, one scaling factor is applied to the quantization step sizes to generate the final quantization step sizes. In one example, this scaling factor is set to ½.

In some embodiments, different quantization step size look-up tables may be applied to video sequences with a different input/internal bit-depth. In one example, only a subset of the quantization step size look-up tables may be employed for the video sequences with an input/internal bit-depth smaller than one threshold. In one example, this threshold is set to 10.

In some embodiments, the quantization step size look-up tables may depend on the color component of the video sequences. In some embodiments, the quantization step sizes from the look-up table may be multiplied by one scaling factor which is derived based on the color component of the video sequences. In one example, when it is luma component, no further scaling factor is applied. If it is chroma component, one scaling factor is applied to the quantization step size to generate the final quantization step size. In one example, this scaling factor is set to ½.

In some embodiments, different quantization step size look-up tables may be applied to different color components of the video sequences. In one example, only a subset of the quantization step size look-up tables may be employed for chroma components of the video.

In some embodiments, different offset look-up tables may be applied to different color components, and/or different input/internal bit depth of video sequences.

In some embodiments, the range of the offset values in the first look-up table may be larger when the input/internal bit depth of the video sequence is larger. In one example, the first look-up table for video sequence with input/internal bit depth equal to 10 or larger is {−10, −7, −3, −1, 0, 1, 3, 7}, and the first look-up table for video sequence with smaller input/internal bit depth is {−7, −5, −3, −1, 0, 1, 3, 5}.

In some embodiments, the range of the offset values in the first look-up table is larger for luma component when compared to the range of the offset values for chroma component. In one example, the first look-up table for luma component is {−10, −7, −3, −1, 0, 1, 3, 7}, and the first look-up table for chroma component is {−7, −5, −3, −1, 0, 1, 3, 5}.

In some embodiments, the offset values from the first look-up table may be multiplied by one scaling factor which is derived based on the color component of the video sequences. In one example, when it is luma component, no further scaling factor is applied. If it is chroma component, one scaling factor is applied to the offset values to generate the final offset values. In one example, this scaling factor is set to ½.

In some embodiments, the first look-up tables may be different for different color components of the video sequences. In one example, only a subset of the allowed first look-up tables may be employed for chroma components of the video. In another example, the scaling factor to multiply the offset values in the look-up table for luma component is from 1 to M, whereas the scaling factor to multiply the offset values in the look-up table for luma component is from 1 to M/2. In one example, M is 4.

In some embodiments, different max band number (both band only option and band classifier combined with edge classifier) may be applied to different color components and may depend on the input or internal bit depth of the video sequences.

FIG. 6B is a flow diagram illustrating a method 650 of encoding video in accordance with some embodiments. The method 650 may be performed at a computing system (e.g., the server system 112, the source device 102, or the electronic device 120) having control circuitry and memory storing instructions for execution by the control circuitry. In some embodiments, the method 650 is performed by executing instructions stored in the memory (e.g., the memory 314) of the computing system. In some embodiments, the method 650 is performed by a same system as the method 600 described above.

The system receives (652) video data comprising a plurality of blocks, including a current block. When the current block has a first property, the system determines (654) a quantization step size for the current block using a first look-up table. When the current block has a second property, the system determines (656) the quantization step size for the current block using a second look-up table. The second property is different than the first property. The second look-up table is different than the first look-up table. The system encodes (658) the current block using the determined quantization step size. As described previously, the encoding process may mirror the decoding processes described herein (e.g., loop filtering, such as cross-component offset filtering). For brevity, those details are not repeated here.

Although FIGS. 6A and 6B illustrate a number of logical stages in a particular order, stages which are not order dependent may be reordered and other stages may be combined or broken out. Some reordering or other groupings not specifically mentioned will be apparent to those of ordinary skill in the art, so the ordering and groupings presented herein are not exhaustive. Moreover, it should be recognized that the stages could be implemented in hardware, firmware, software, or any combination thereof.

Turning now to some example embodiments.

(A1) In one aspect, some embodiments include a method (e.g., the method 600) of video decoding. In some embodiments, the method is performed at a computing system (e.g., the server system 112) having memory and control circuitry. In some embodiments, the method is performed at a coding module (e.g., the coding module 320). In some embodiments, the method is performed at a source coding component (e.g., the source coder 202), a coding engine (e.g., the coding engine 212), and/or an entropy coder (e.g., the entropy coder 214). The method includes (i) receiving a video bitstream (e.g., a coded video sequence) comprising a plurality of blocks, including a current block; (ii) when the current block has a first property, determining a quantization step size for the current block using a first look-up table; (iii) when the current block has a second property, determining the quantization step size for the current block using a second look-up table, wherein the second property is different than the first property, and wherein the second look-up table is different than the first look-up table; and (iv) reconstructing the current block using the determined quantization step size. In this way, different quantization step size (or quantization threshold) look-up tables may be applied to different color components, different input/internal bit depth of video sequences, and/or different edge classifiers. In some embodiments, different offset look-up tables are applied to different color components and/or different input/internal bit depth of video sequences.

(A2) In some embodiments of A1, the first property corresponds to a first color component and the second property corresponds to a second color component. For example, the quantization step size look-up tables may depend on the color component of the video sequences. As an example, different quantization step size look-up tables may be applied to different color components of the video sequences. For example, only a subset of the quantization step size look-up tables may be employed for chroma components of the video. In some embodiments, the range of the offset values in the first look-up table is larger for a luma component when compared to the range of the offset values for a chroma component. For example, the first look-up table for luma component is {−10, −7, −3, −1, 0, 1, 3, 7}, and the first look-up table for chroma component is {−7, −5, −3, −1, 0, 1, 3, 5}. In some embodiments, the first look-up tables are different for different color components of the video sequences. As an example, only a subset of the allowed first look-up tables may be employed for chroma components of the video. As another example, the scaling factor to multiply the offset values in the look-up table for luma component is from 1 to M, whereas the scaling factor to multiply the offset values in the look-up table for luma component is from 1 to M/2. In one example, M is 4.

(A3) In some embodiments of A1 or A2, the first property corresponds to a first bit depth and the second property corresponds to a second bit depth. For example, different quantization step size look-up tables may be applied to video sequences with a different input/internal bit-depth. In some embodiments, only a subset of the quantization step size look-up tables may be employed for the video sequences with an input/internal bit-depth smaller than a threshold. In one example, the threshold is set to 10.

(A4) In some embodiments of A3, the first and second bit depths are internal bit depths or input bit depths. For example, the quantization step size look-up tables may depend on the input or internal bit depth of the video sequences.

(A5) In some embodiments of A3 or A4, a range of the first look-up table increases as the first bit depth increases. For example, the range of the offset values in the first look-up table may be larger when the input/internal bit depth of the video sequence is larger. In some embodiments, the first look-up table is selected from a set of look-up tables based on the first bit depth. In some embodiments, the second look-up table is selected from a set of look-up tables based on the second bit depth. As an example, the first look-up table for video sequence with input/internal bit depth equal to 10 or larger is {−10, −7, −3, −1, 0, 1, 3, 7}, and the first look-up table for video sequence with smaller input/internal bit depth is {−7, −5, −3, −1, 0, 1, 3, 5}.

(A6) In some embodiments of any of A1-A5, determining the quantization step size for the current block comprises multiplying a value from the first look-up table or second look-up table by a scaling factor. For example, the quantization step sizes from the look-up table may be multiplied by one scaling factor which is derived based on the color component of the video sequences. As an example, when it is luma component, no further scaling factor is applied. If it is chroma component, one scaling factor is applied to the quantization step size to generate the final quantization step size. In one example, this scaling factor is set to ½. In some embodiments, the offset values from the first look-up table are multiplied by a scaling factor that is derived based on the color component of the video sequences. For example, when it is luma component, no further scaling factor may be applied. If it is chroma component, a scaling factor is applied to the offset values to generate the final offset values. In one example, this scaling factor is set to ½.

(A7) In some embodiments of A6, the scaling factor is based on a bit depth associated with the current block. For example, the quantization step sizes values from the look-up table may be multiplied by one scaling factor that is derived based on the input/internal bit-depth of the video sequences. As an example, when the internal/input bit depth of the video sequence is equal to 10, no further scaling factor is applied. If the internal/input bit depth of the video sequence is smaller than 10, such as 8, one scaling factor is applied to the quantization step sizes to generate the final quantization step sizes. In one example, this scaling factor is set to ½.

(A8) In some embodiments of any of A1-A7, the first property corresponds to a first edge classifier and the second property corresponds to a second edge classifier.

(A9) In some embodiments of A8, the first edge classifier comprises three intervals; the second edge classifier comprises two intervals; the first look-up table consists of non-negative integers; and the second look-up table comprises one or more negative integers. For example, all the quantization step sizes in the look-up table are non-negative (or positive) integers for the edge classier with 3 intervals whereas there is at least one quantization step size is negative (or zero) integer for the edge classifier with 2 quantization intervals. As an example, half of the quantization step sizes for the edge classifier with 2 quantization intervals may be negative integers. As another example, the quantization step sizes for the edge classifier with 2 quantization intervals may be {16, 32, −16, −32}. As another example, the quantization step sizes for the edge classifier with 2 quantization intervals may be {8, 16, −8, −16}.

(A10) In some embodiments of any of A1-A9, the first look-up table consists of non-negative integers for quantization step sizes. For example, all the quantization step sizes in the first look-up table may be non-negative (or positive) integers for the first set of edge classifier whereas at least one of the quantization step sizes in the second look-up table are negative (or zero) integer for the second set of edge classifier.

(A11) In some embodiments of any of A1-A10, the second look-up table comprises one or more negative integers for quantization step sizes.

(A12) In some embodiments of any of A1-A11, a band number for a band classifier applied to the current block is based on whether the current block has the first property or the second property. For example, different max band number (both band only option and band classifier combined with edge classifier) may be applied to different color components and may depend on the input or internal bit depth of the video sequences.

(B1) In another aspect, some embodiments include a method (e.g., the method 650) of video encoding. In some embodiments, the method is performed at a computing system (e.g., the server system 112) having memory and control circuitry. In some embodiments, the method is performed at a coding module (e.g., the coding module 320). The method includes: (i) receiving video data (e.g., a source video sequence) comprising a plurality of blocks, including a current block; (ii) when the current block has a first property, determining a quantization step size for the current block using a first look-up table; (iii) when the current block has a second property, determining the quantization step size for the current block using a second look-up table, wherein the second property is different than the first property, and wherein the second look-up table is different than the first look-up table; and (iv) encoding the current block using the determined quantization step size. In some embodiments, the method further includes transmitting encoded information for the current block in a video bitstream.

(B2) In some embodiments of B1, the first property corresponds to a first color component and the second property corresponds to a second color component.

(B3) In some embodiments of B1 or B2, the first property corresponds to a first bit depth and the second property corresponds to a second bit depth.

(B4) In some embodiments of any of B1-B3, determining the quantization step size for the current block comprises multiplying a value from the first look-up table or second look-up table by a scaling factor.

(C1) In another aspect, some embodiments include a method of storing a video bitstream that is generated by a video encoding method. The video bitstream comprises coded information for a plurality of blocks including a current block. The video encoding method comprises: (i) when the current block has a first property, determining a quantization step size for the current block using a first look-up table; (ii) when the current block has a second property, determining the quantization step size for the current block using a second look-up table, wherein the second property is different than the first property, and wherein the second look-up table is different than the first look-up table; and (iii) encoding the current block using the determined quantization step size.

(C2) In some embodiments of C1, the first property corresponds to a first color component and the second property corresponds to a second color component.

(C3) In some embodiments of C1 or C2, the first property corresponds to a first bit depth and the second property corresponds to a second bit depth.

(C4) In some embodiments of any of C1-C3, determining the quantization step size for the current block comprises multiplying a value from the first look-up table or second look-up table by a scaling factor.

In another aspect, some embodiments include a computing system (e.g., the server system 112) including control circuitry (e.g., the control circuitry 302) and memory (e.g., the memory 314) coupled to the control circuitry, the memory storing one or more sets of instructions configured to be executed by the control circuitry, the one or more sets of instructions including instructions for performing any of the methods described herein (e.g., A1-A12, B1-B4, and C1-C4 above).

In yet another aspect, some embodiments include a non-transitory computer-readable storage medium storing one or more sets of instructions for execution by control circuitry of a computing system, the one or more sets of instructions including instructions for performing any of the methods described herein (e.g., A1-A12, B1-B4, and C1-C4 above). In some embodiments, a memory or non-transitory computer-readable storage medium stores a video bitstream including any of the features (e.g., syntax and encoded information) disclosed herein.

Unless otherwise specified, any of the syntax elements (e.g., indicators) described herein may be high-level syntax (HLS). As used herein, HLS is signaled at a level that is higher than a block level. For example, HLS may correspond to a sequence level, a frame level, a slice level, or a tile level. As another example, HLS elements may be signaled in a video parameter set (VPS), a sequence parameter set (SPS), a picture parameter set (PPS), an adaptation parameter set (APS), a slice header, a picture header, a tile header, and/or a CTU header.

It will be understood that, although the terms “first,” “second,” etc. may be used herein to describe various elements, these elements should not be limited by these terms. These terms are only used to distinguish one element from another. The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purposes of explanation, has been described with reference to specific embodiments. However, the illustrative discussions above are not intended to be exhaustive or limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A method of video decoding performed at a computing system having memory and one or more processors, the method comprising:
receiving a video bitstream comprising a plurality of blocks, including a current block;
when the current block has a first property, determining a quantization step size for the current block using a first look-up table;
when the current block has a second property, determining the quantization step size for the current block using a second look-up table, wherein the second property is different than the first property, and wherein the second look-up table is different than the first look-up table; and
reconstructing the current block using the determined quantization step size.

2. The method of claim 1, wherein the first property corresponds to a first color component and the second property corresponds to a second color component.

3. The method of claim 1, wherein the first property corresponds to a first bit depth and the second property corresponds to a second bit depth.

4. The method of claim 3, wherein the first and second bit depths are internal bit depths or input bit depths.

5. The method of claim 3, wherein a range of the first look-up table increases as the first bit depth increases.

6. The method of claim 1, wherein determining the quantization step size for the current block comprises multiplying a value from the first look-up table or second look-up table by a scaling factor.

7. The method of claim 6, wherein the scaling factor is based on a bit depth associated with the current block.

8. The method of claim 1, wherein the first property corresponds to a first edge classifier and the second property corresponds to a second edge classifier.

9. The method of claim 8, wherein:
the first edge classifier comprises three intervals;
the second edge classifier comprises two intervals;
the first look-up table consists of non-negative integers; and
the second look-up table comprises one or more negative integers.

10. The method of claim 1, wherein the first look-up table consists of non-negative integers for quantization step sizes.

11. The method of claim 1, wherein the second look-up table comprises one or more negative integers for quantization step sizes.

12. The method of claim 1, wherein a band number for a band classifier applied to the current block is based on whether the current block has the first property or the second property.

13. A method of video encoding performed at a computing system having memory and one or more processors, the method comprising:
receiving video data comprising a plurality of blocks, including a current block;
when the current block has a first property, determining a quantization step size for the current block using a first look-up table;
when the current block has a second property, determining the quantization step size for the current block using a second look-up table, wherein the second property is different than the first property, and wherein the second look-up table is different than the first look-up table; and
encoding the current block using the determined quantization step size.

14. The method of claim 13, wherein the first property corresponds to a first color component and the second property corresponds to a second color component.

15. The method of claim 13, wherein the first property corresponds to a first bit depth and the second property corresponds to a second bit depth.

16. The method of claim 13, wherein determining the quantization step size for the current block comprises multiplying a value from the first look-up table or second look-up table by a scaling factor.

17. A non-transitory computer-readable storage medium storing a video bitstream that is generated by a video encoding method, the video bitstream comprising:
coded information for a plurality of blocks including a current block; and
wherein the video encoding method comprises:
when the current block has a first property, determining a quantization step size for the current block using a first look-up table;
when the current block has a second property, determining the quantization step size for the current block using a second look-up table, wherein the second property is different than the first property, and wherein the second look-up table is different than the first look-up table; and
encoding the current block using the determined quantization step size.

18. The non-transitory computer-readable storage medium of claim 17, wherein the first property corresponds to a first color component and the second property corresponds to a second color component.

19. The non-transitory computer-readable storage medium of claim 17, wherein the first property corresponds to a first bit depth and the second property corresponds to a second bit depth.

20. The non-transitory computer-readable storage medium of claim 17, wherein determining the quantization step size for the current block comprises multiplying a value from the first look-up table or second look-up table by a scaling factor.
